(19) United States
(12) Patent Application Publication
(10) Pub. No.: US 2006/0174075 A1
(43) Pub. Date: Aug. 3, 2006

(54) Method for creating and preserving snapshots in a storage system

(76) Inventor: Atsushi Sutoh, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/065,247

(22) Filed: Feb. 25, 2005

(30) Foreign Application Priority Data
Jan. 31, 2005 (JP) 2005-023546

(51) Int. Cl. G06F 12/16

(52) U.S. Cl. 711/162

(57) ABSTRACT

The reduction of the volume capacity necessary to copy the snapshot can be achieved. When an operation volume is updated, the data before the update is saved in a difference storing volume, and the data of the two volumes, that is, the operation volume and the difference storing volume are combined to constitute the snapshot. In order to constitute the snapshot, the data necessary to constitute the snapshot is copied to the snapshot saving volume by using the block copy management table in which the data location in the operation volume and the difference storing volume is recorded, and another block copy management table for retaining the data location after the copy is saved in the volume. The saved snapshot can be referenced by accessing the snapshot saving volume, to which the data constituting the snapshot is copied, by using the snapshot read program.

### CROSS-REFERENCE TO RELATED APPLICATION

The present application claims priority from Japanese Patent Application JP 2005-23546 filed on Jan. 31, 2005, the content of which is hereby incorporated by reference into this application.

### TECHNICAL FIELD OF THE INVENTION

The present invention relates to a technique for realizing a snapshot function in a storage system, and more particularly, it relates to a technique effectively applied to the method of creating and keeping a snapshot by using a logical volume manager.

### BACKGROUND OF THE INVENTION

As the use of information systems has been expanding more and more, the capacity of the storages for storing the data has been also increasing. According to this, the value of the data stored in the storages rises and the destruction of data due to unauthorized accesses to data or erroneous operations results in a great loss in the management of information systems. Therefore, data protection functions become more and more important for the purpose of the prevention of data destruction and the recovery of data when data is destructed.

A snapshot function is used as one of the data protection functions of the storage system. By using the snapshot function, the data is stored in the storage system, and a snapshot which is a still image of the data of an operating volume at a certain point can be created and kept. The snapshot can be accessed by the means different from that of the operating volume, and the data at the point of the creation thereof can be referenced. Therefore, even when the data in the operating volume is destructed, the data at the point of snapshot creation can be recovered.

As the method for creating and keeping the snapshot, for example, a method utilizing the logical volume function of a server system which processes and controls the data and a method utilizing the file system function are known.

In the method utilizing the logical volume function, for example, the logical volume manager (LVM) of Linux Kernel is available (refer to “LVM HOWTO” by A J Lewis, http://ibiblio.org/pub/Linux/docs/HOWTO/other-formats/pdf/LVM-HOWTO.pdf). When the snapshot of an operating volume is created by the LVM, that is, when the snapshot of the operating logical volume is created, it is necessary to prepare another logical volume to be used as a logical volume for storing difference. Then, when the update (write) is performed in the operating logical volume after the creation of the snapshot, the data before the update is copied to the logical volume for storing difference. The LVM has a constitutional function to combine the data of the operating logical volume and that of the logical volume for storing difference so as to create the volume image at the time of the snapshot creation as a snapshot in the form of the virtual logical volume. This function can be realized by the table that shows which the operating logical volume or the logical volume for storing difference the snapshot data is present in.

Further, in the method of utilizing the file system function, the write-anywhere file system is available (for example, U.S. Pat. No. 5,819,292). In the write-anywhere file system, the snapshot is created in the following manner. The file system retains the data location block of the file in an inode, and when the file is changed after the creation of the snapshot, the inode is copied to retain the location of changed part of the data in the newly copied inode. Then, the inode before changing the file is used as the inode for snapshot. When accessing the operating file system, the data location is recognized by using the latest inode, and when accessing the snapshot, the data location is recognized by using the inode for snapshot. In this manner, the access to each data is enabled.

By creating the snapshot in the above-described manner, it is possible to store the past volume image and file system image while maintaining the accesses to the operating volume and the file system. Further, it is also possible to recover the data deleted by mistake and to backup the data into the medium other than the disk drive with reference to the snapshot.

In addition, another data protection method is known, in which the snapshots are copied to other medium while maintaining the time order of the snapshots.

For example, when the snapshot is created by the LVM, the operating logical volume and the logical volume for storing difference are copied by using the volume copy function of the storage system (e.g., “Hitachi ShadowImage” by Hitachi Ltd. http://www.hitachi.co.jp/Prod/comp/storage/diskarray/products/software/r_shadow/index.html). By doing so, it is possible to copy the data of volume necessary for keeping the snapshot.

Also, in another method, in the case where the snapshot is created in the file system, it is possible to copy the snapshot by determining the change between the two snapshots and transmitting the change to another server (for example, Japanese Patent Application Laid-Open No. 2004-38928).

### SUMMARY OF THE INVENTION

As the methods for copying the snapshot to the volume other than the operating volume and the volume for storing difference, the followings are known, that is, the method in which the snapshot is copied to other volume as one volume, the method in which all of the operating volume and the volume for storing difference are copied to other volumes, and the method in which the difference is searched in each file and the searched difference is copied.

In the method in which the snapshot is copied to other volume as one volume, to copy the snapshot, one volume is prepared and the snapshot is stored therein. Therefore, the prepared volume must have the capacity as large as that of the snapshot. As a result, there is a problem that a large number of volumes are required when the number of snapshots to be stored is increased.

Similarly, in the method in which all of the operating volume and the volume for storing difference are copied to other volumes, a large number of volumes are required. The snapshot created by the logical volume function includes the data of the volume operated most recently, which does not need to be referenced after the creation of the snapshot. Also, if the difference data for constituting the snapshot is present for a certain data, since the same data part present in the operating volume is not referenced; the data part does not need to be copied. However, since the whole volume is copied in this method, the data which does not need to be copied must be stored. As a result, the volume utilization is increased.

In the method in which the difference is searched in each file, the two problems described above do not occur. However, since it is necessary to search the difference in each file, it takes a long time for the process of searching the difference in the case of the file system having a large number of files.

Therefore, an object of the present invention is to provide the technique capable of reducing the volume capacity required to store the copy of the snapshot and to copy the snapshot at processing amount which is independent of the number of file of the file system.

The present invention is applied to the storage system having the method of creating and keeping the snapshot by a logical volume.

When keeping the snapshot, the operation volume used to operate the file system, the difference storing volume which stores the difference which occurs when the data of the operation volume is updated after the creation of the snapshot, and the snapshot saving volume which moves the difference of the snapshot to save the snapshot are used in combination.

While creating and keeping the snapshot, the operation volume and the difference storing volume, and the block copy management table in which the data location condition in these volumes is saved to constitute the snapshot are used in the operation. When storing the difference of the operation volume in the difference storing volume, the block of the difference storing volume to which the difference of the operation volume is copied and the snapshot to which the difference of the operation volume belongs are saved in the block copy management table. Then, when the snapshot is referenced, the information of the block copy management table is used so that the data in the operation volume and that in the difference storing volume are combined to constitute the snapshot.

When one snapshot is moved to the snapshot saving volume, the data movement is instructed by a command and the like. Then, the data stored in the difference storing volume is copied to the snapshot saving volume with reference to the block copy management table, and thereafter, the information of the block copy management table is changed. More specifically, the change from the difference storing volume to the snapshot saving volume and the change of the block to which the data is copied are reflected in the block copy management table. Also, when the difference from the operation volume is generated after starting the data copy, the storage destination of the difference data is changed to the snapshot saving volume. It is possible to specify either one snapshot or a plurality of snapshots in this sequence. As described above, by changing the device which stores the difference, the snapshot is moved to the snapshot saving volume while keeping the snapshot.

Furthermore, in order to separate the snapshot saving volume from the operation of the snapshot so as to enable the independent reference thereof, the process described below is further performed. The necessary data in the operation volume is selected with reference to the block copy management table and stored in the snapshot saving volume. At this time, the block copy management table which manages the locations of the storage destination of difference data and the copy destination of the data of the operation volume is also saved in the snapshot saving volume. By doing so, the data necessary to establish the snapshot are all stored in the snapshot saving volume.

In the case of independently referencing the snapshot saving volume, the block copy management table is read from the snapshot saving volume to access the data on the snapshot saving volume by using the information of the table.

According to the present invention, when saving the snapshot, the data necessary to save the snapshot is selected by using the information of the block copy management table. That is, if the data of the snapshot is saved as the difference, the duplicate save the data from the operation volume becomes unnecessary. Therefore, the volume capacity necessary to save the snapshot can be reduced in comparison to the method in which the whole volume is copied.

Also, according to the present invention, the information searched when saving the difference depends on the size of the operation volume, that is, the number of blocks, and is not influenced by the number of files. More specifically, even in the file system having a large number of files, the process necessary to search the difference depends only on the size of the volume and block. Therefore, in the case that a number of files are saved, the process necessary to search the difference can be reduced in comparison to the method using the file system.

### BRIEF DESCRIPTIONS OF THE DRAWINGS

FIG. 1 is a block diagram showing an example of the configuration of the storage system according to a first embodiment of the present invention;

FIG. 2 is an explanatory diagram showing an example of the configuration of a snapshot management program according to the first embodiment of the present invention;

FIG. 3 is an explanatory diagram showing an example of a block copy management table according to the first embodiment of the present invention;

FIG. 4 is an explanatory diagram showing an example of a used block management table (difference storing volume) according to the first embodiment of the present invention;

FIG. 5 is an explanatory diagram showing an example of a used block management table (snapshot saving volume) according to the first embodiment of the present invention;

FIG. 6 is an explanatory diagram showing an example of a copy destination management table according to the first embodiment of the present invention;

FIG. 7 is a flow diagram showing an example of the operation of an initialization subprogram according to the first embodiment of the present invention;

FIG. 8 is a flow diagram showing an example of the operation of a snapshot creation subprogram according to the first embodiment of the present invention;

FIG. 9 is a flow diagram showing an example of the operation of a snapshot deletion subprogram according to the first embodiment of the present invention;

FIG. 10 is a flow diagram showing an example of the operation of a read operation subprogram according to the first embodiment of the present invention;

FIG. 11 is a flow diagram showing an example of the operation of a write operation subprogram according to the first embodiment of the present invention;

FIG. 12 is a flow diagram showing an example of the operation of a snapshot moving subprogram according to the first embodiment of the present invention;

FIG. 13 is a flow diagram showing an example of the operation of a saving volume separation subprogram according to the first embodiment of the present invention;

FIG. 14 is a flow diagram showing an example of the operation of the saving volume separation subprogram (subsequent to FIG. 13) according to the first embodiment of the present invention; and

FIG. 15 is a flow diagram showing an example of the operation of a saving volume reconnection subprogram according to the first embodiment of the present invention.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

In the present invention, an object of the reduction of the volume capacity necessary to save the copy of the snapshot can be achieved by using the information of the block copy management table which is necessary to create and keep the snapshot, and the present invention is characterized in that, when saving the copy of the snapshot, the necessary information is selected with reference to the block copy management table, and the snapshot is copied and processed to the volume for saving the snapshot.

In the present invention, the following two methods will be described. The first is the method in which the block copy management table in the volume in which the snapshot is saved is used to reference the saved snapshot copy (first embodiment), and the second is the method in which both of the block copy management table in the volume in which the snapshot is saved and the block copy management table retained by the logical volume manager are used (second embodiment). Both methods will be described below in detail.

### First Embodiment

This embodiment will describe an example in which the saved snapshot is referenced by using the block copy management table in the volume in which the snapshot is saved.

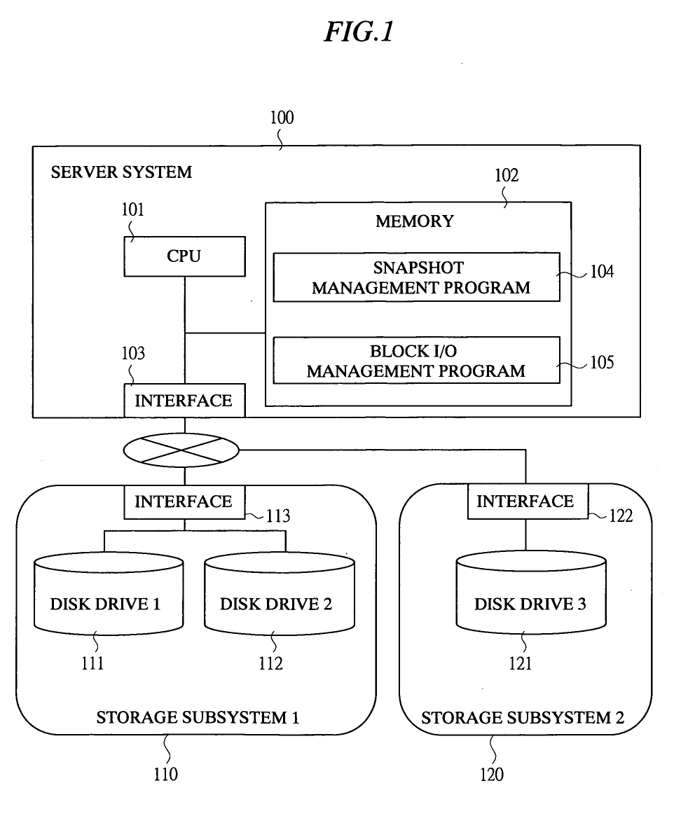

FIG. 1 is a block diagram showing an example of the system configuration of the storage system according to the first embodiment of the present invention.

The storage system of this embodiment comprises a server system 100, a storage subsystem 110, and a storage subsystem 120.

The server system 100 is provided with a CPU 101 having a function as a control unit for performing processes, a memory 102 for retaining the data which is required for the processes performed in the server system 100 and software which is executed by the CPU 101, and an interface 103 having a function as a connection device for connecting the server system 100 and the storage subsystems 110 and 120 so as to perform data transfer between them.

Usually, various programs are operated on the server system. For example, the NFS server program as a network attached storage and a program for providing various services such as database management system which manages the database are enumerated. However, such programs are not illustrated because the description in this case is focused on the snapshot of the volume.

In addition to the programs for providing these services, a snapshot management program 104 and a block I/O management program 105 for issuing the block I/O to the storage subsystem 110 and the storage subsystem 120 are provided in the memory 102 as the softwares operated in the server system 100.

The snapshot management program 104 manages the operation volume, the difference storing volume, and the snapshot saving volume and creates and keeps the snapshot to enable the access to each volume and snapshot. Further, the snapshot management program 104 makes it possible to store the snapshot in the snapshot saving volume and to access the snapshot stored in the snapshot saving volume.

The block I/O management program 105 converts the access request to the volume of the snapshot management program 104 into the command to the storage subsystem 110 and the storage subsystem 120 via the interface 103 to perform the data access to the volume. For example, the block I/O management program 105 corresponds to the block device driver or the SCSI driver in the Linux Kernel.

The storage subsystem 110 is provided with disk drives 111 and 112 having a function as storage devices for retaining data and an interface 113 having a function as a connection device for connecting the storage subsystem 110 and the server system 100 so as to perform data transfer between them.

Also, the storage subsystem 120 is provided with a disk drive 121 having a function as a storage device for retaining data and an interface 122 having a function as a connection device for connecting the storage subsystem 120 and the server system 100 so as to perform data transfer between them.

In each of the disk drives 111, 112, and 121, a predetermined size is set as a block which is a unit for managing data and access can be performed in units of block. Therefore, in data read or data write and access to other data, the data has to be specified in units of block. The disk drives 111, 112, and 121 in which data is saved and the data can be referenced later may be single disk drives or can be obtained by dividing one disk drive into a plurality of regions called partitions. Alternatively, the RAID (Redundant Arrays of Inexpensive Disks) which integrally manages a plurality of disk drives is also available. In addition, it is also possible to use a plurality of disk drives as one logical disk drive.

In this embodiment, the snapshot management program 104 operated in the server system 100 uses the disk drive 111 as the operation volume, the disk drive 112 as the difference storing volume, and the disk drive 121 as the snapshot saving volume. The configuration described above intends to facilitate the management of the snapshot by providing the snapshot storing volume in the storage subsystem different from a normal operation volume. However, any types of the volumes are available for the operation volume, the difference storing volume, and the snapshot saving volume as long as they can be recognized as different volumes by the snapshot management program 104. Therefore, it is also possible to arrange all of the volumes in the same storage subsystem in the embodiments of the present invention. Further, it is not always necessary to prepare different disk drives for the volumes, and the partitions of the disk drive and the volume obtained by combining a plurality of disk drives are also available.

Further, in this embodiment, write to the snapshot is prohibited and the snapshot is described as a read-only volume. However, it is possible to perform the write to the snapshot if the snapshot management program 104 is modified.

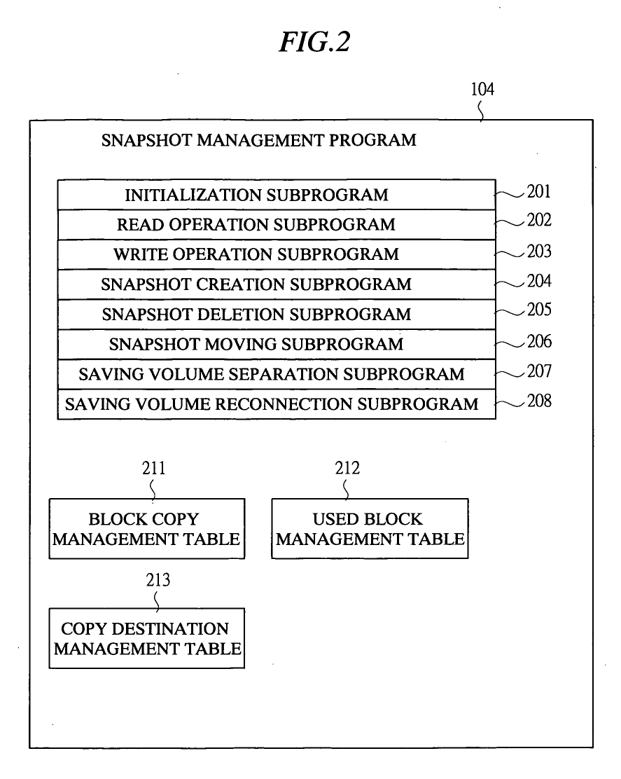

Next, the snapshot management program 104 which operates in the server system 100 will be described with reference to FIGS. 2 to 6.

FIG. 2 is an explanatory diagram showing a configuration example of the snapshot management program 104. The snapshot management program 104 controls the access to the operation volume, the difference storing volume, and the snapshot saving volume and creates the snapshot from the software operated in the server system 100. The software modules and data configuration which constitute the snapshot management program 104 will be described with reference to FIG. 2.

The snapshot management program 104 comprises a subprogram group including an initialization subprogram 201, a read operation subprogram 202, a write operation subprogram 203, a snapshot creation subprogram 204, a snapshot deletion subprogram 205, a snapshot moving subprogram 206, a saving volume separation subprogram 207, and a saving volume reconnection subprogram 208 and a data management table group including a block copy management table 211, a used block management table 212, and a copy destination management table 213.

First, the subprogram group which constitutes the snapshot management program 104 will be described.

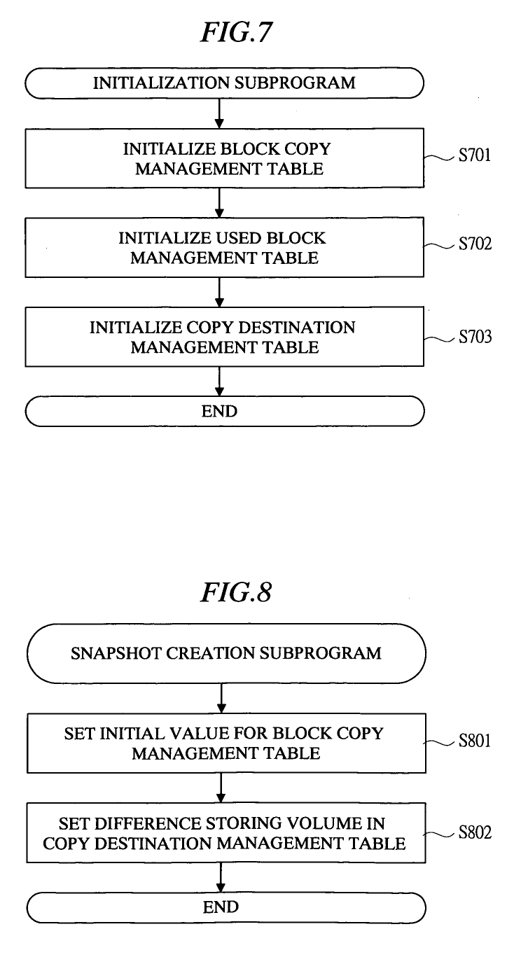

The initialization subprogram 201 manages the table group retained by the snapshot management program 104. For example, when the disk drives 111, 112, and 121 are used as the operation volume, the difference storing volume, and the snapshot saving volume, respectively, the initialization subprogram 201 initializes the data management table group retained by the snapshot management program 104 for managing them. This will be described later with reference to FIG. 7.

The read operation subprogram 202 is used for the data reference to the operation volume and the snapshot by using the block copy management table 211 and the copy destination management table 213. The process will be described later in detail with reference to FIG. 10.

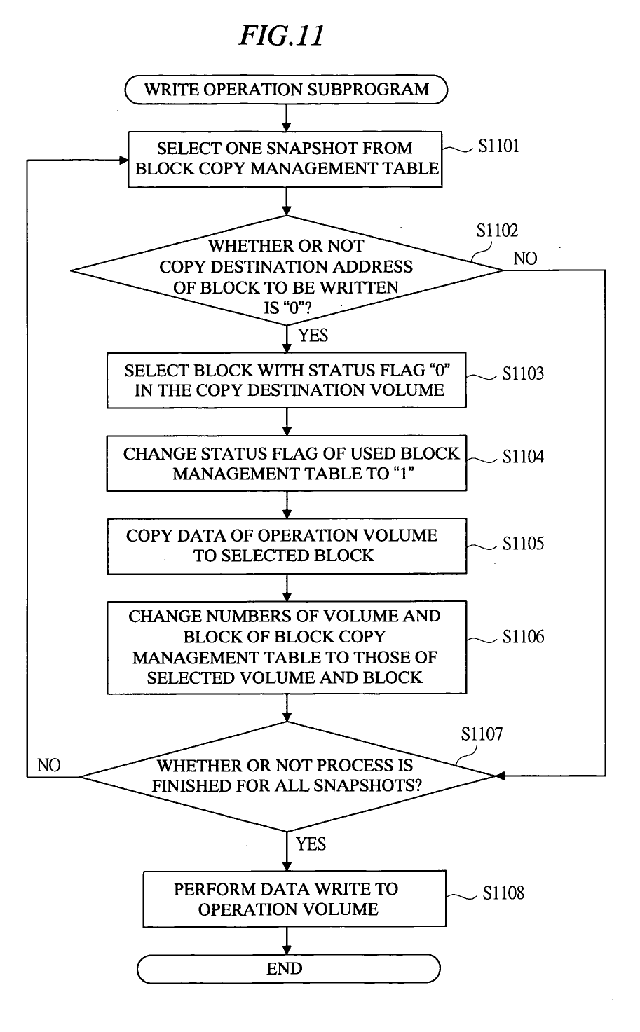

The write operation subprogram 203 executes the process necessary to control the write to the operation volume and keep the snapshot. The write operation subprogram 203 is invoked every time when the write to the operation volume is performed, performs the write to the operation volume, and keeps the snapshot. At this time, it copies the difference data to the difference storing volume and updates the block copy management table 211. The process will be described later in detail with reference to FIG. 11.

The snapshot creation subprogram 204 is executed when creating the snapshot of the operation volume. This execution makes the snapshot accessible. This program updates the block copy management table 211 and the copy destination management table 213. The process will be described later in detail with reference to FIG. 8.

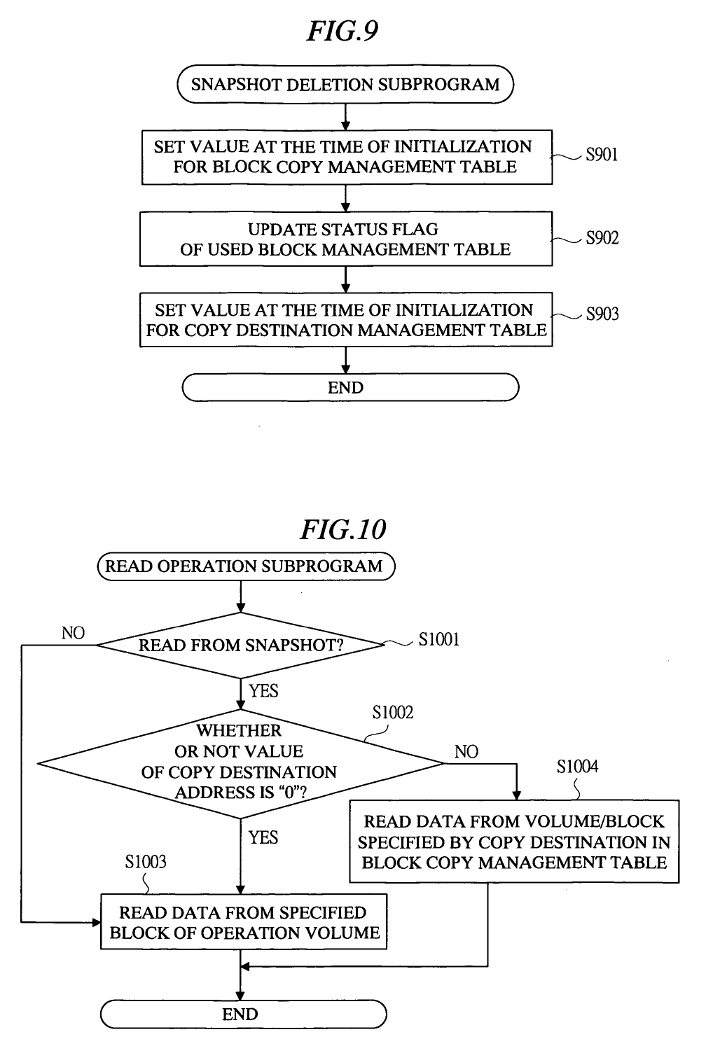

The snapshot deletion subprogram 205 is executed when deleting the created snapshot. This program updates the block copy management table 211 and the copy destination management table 213 and performs the process of releasing the region which retains the difference in the difference storing volume and the snapshot saving volume. The process sequence will be described later in detail with reference to FIG. 9.

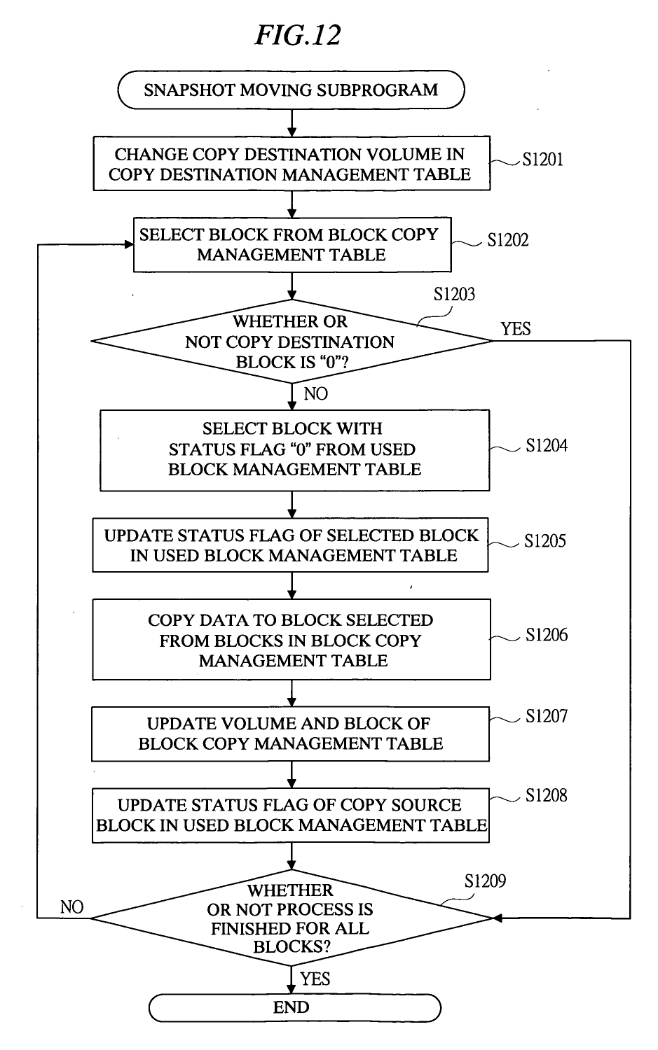

The snapshot moving subprogram 206 moves the snapshot whose difference is saved in the difference storing volume to the snapshot saving volume. At this time, it copies the difference data from the difference storing volume to the snapshot saving volume and simultaneously updates the block copy management table 211 and the copy destination management table 213. When copying the difference data, the used block management table 212 is updated. The process will be described later in detail with reference to FIG. 12.

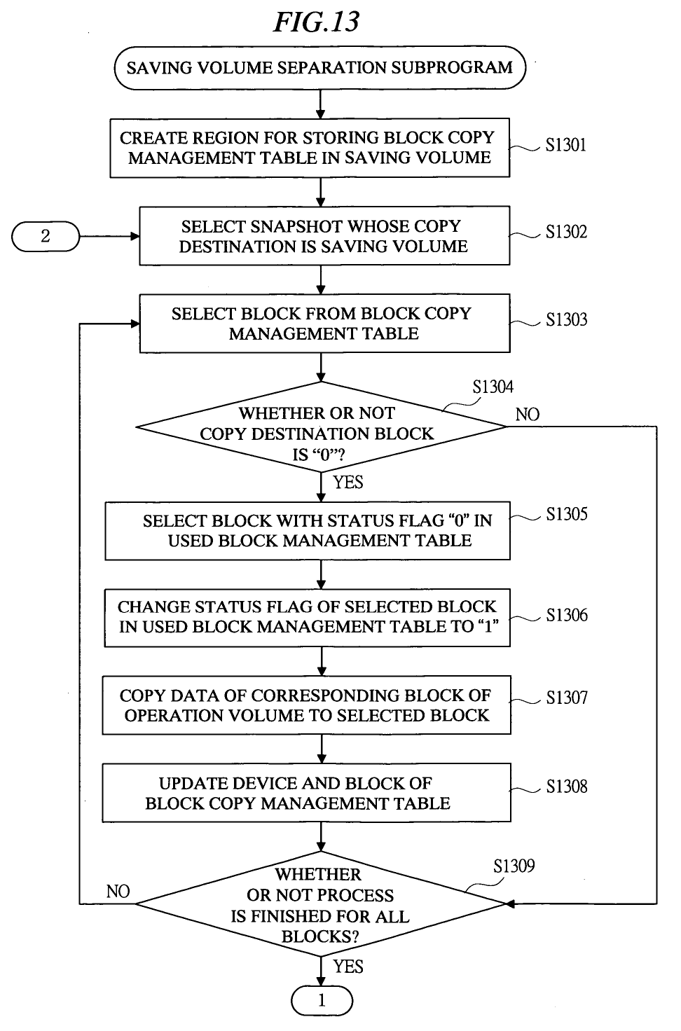

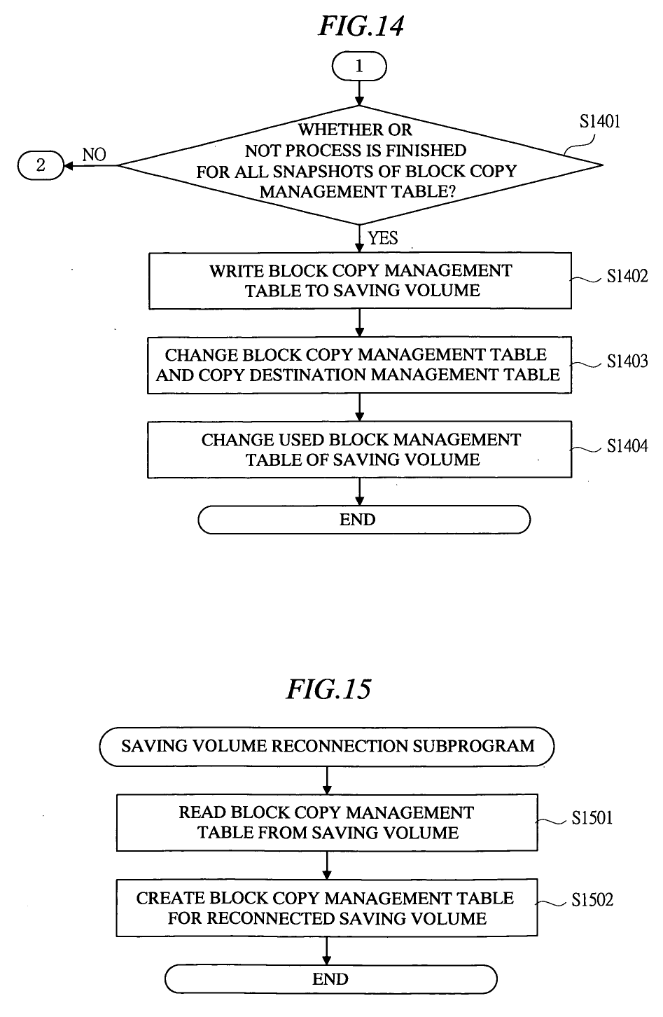

The saving volume separation subprogram 207 separates the snapshot saving volume from the operation so that the snapshot can be referenced independently. This program copies the data in the operation volume to the snapshot saving volume and updates the block copy management table 211 and the used block management table 212. Further, it writes the block copy management table 211 to the snapshot saving volume. The process will be described later in detail with reference to FIGS. 13 and 14.

The saving volume reconnection subprogram 208 recognizes the snapshot saving volume separated by the saving volume separation subprogram 207 and performs the process of referencing the snapshot. This program reads the block copy management table 211 from the snapshot saving volume to provide it in the memory 102. At the same time, it establishes the data management table group to create the information necessary for referencing the snapshot. After that, similar to the case of using the pair of the operation volume and the difference storing volume, the snapshot can be referenced by using the data only in the snapshot saving volume. The process will be described later in detail with reference to FIG. 15.

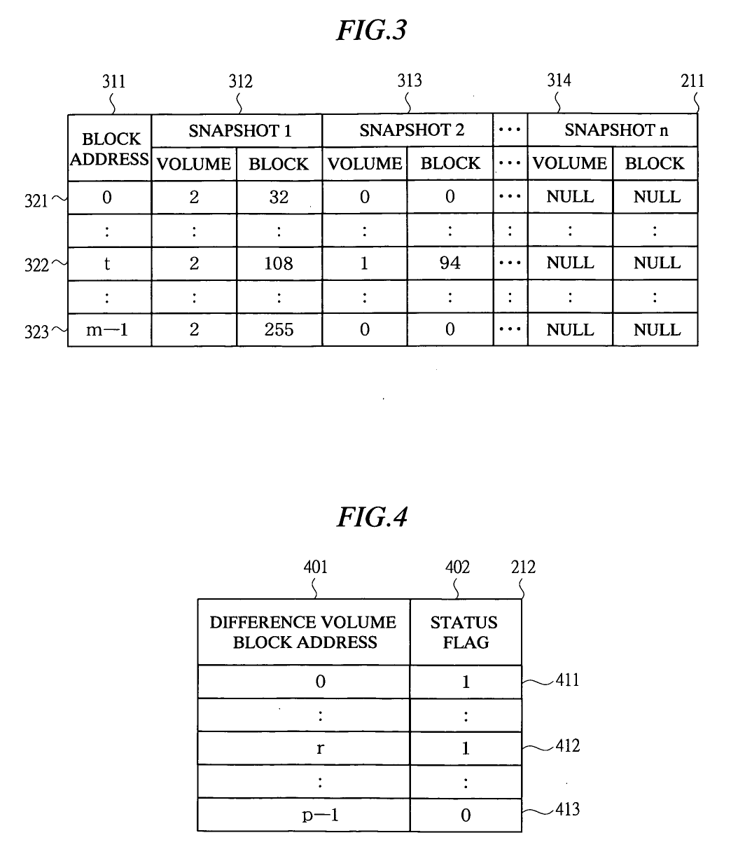

Next, the data management table group constituting the snapshot management program 104 will be described with reference to FIGS. 3 to 6.

The block copy management table 211 saves the blocks to which the data of the operation volume is copied in the difference storing volume and the snapshot saving volume in order to keep the snapshot. The detail thereof will be described with reference to FIG. 3. The block copy management table 211 comprises the block address 311 of the operation volume and the columns showing the copy destination of the difference data of each snapshot corresponding thereto. In this embodiment, the number of blocks of the operation volumes is m and the number of snapshots is n at most. Therefore, the block addresses 311 from 0 to m−1 and columns from 1 to n each showing the information of the snapshot are provided. Also, a number is allocated to each of the volumes present in the columns in order to show the volume in use, and the volume 0 represents the operation volume, the volume 1 represents the difference storing volume, and the volume 2 represents the snapshot saving volume.

For example, the volume of the snapshot 1 is “2” and the block thereof is “32” as shown at the intersection of the column 312 and the row 321. More specifically, it can be understood that the block address 0 of the snapshot 1 can be referenced by referencing the block address 32 of the snapshot saving volume. Similarly, as shown at the intersection of the column 313 and the row 322, the block address t of the snapshot 2 can be referenced by referencing the data of the block address “94” of the difference storing volume. As shown at the intersection of the column 313 and the row 321, both the volume and the block of the block address 0 of the snapshot 2 are “0”. This shows that the difference data has not been generated yet, and the data can be referenced from the operation volume. Also, all values of the columns 314 of the snapshot n are “null”. This shows the state that the snapshot n is not created.

The used block management table 212 manages the status of use so as to avoid the duplicate use of the block to which the difference data is copied in the difference storing volume and the snapshot saving volume and the block used to save the block copy management table 211. The used block management table 212 is shown as one object in FIG. 2. However, it is not always one object. In this embodiment, the table is created for each of the difference storing volume and the snapshot saving volume. FIG. 4 shows an example of the used block management table 212 of the difference storing volume, and FIG. 5 shows an example of the used block management table 212 of the snapshot saving volume.

In this embodiment, p blocks from 0 to p−1 are provided in the difference storing volume as shown in FIG. 4. A status flag 402 which represents whether or not the block is used is recorded for each of the difference volume block addresses 401. For example, in the row 411 in which the difference volume block address 401 is 0 or the row 412 in which the block address is r, the status flag 402 is “1” which represents that the block is in use. On the other hand, the status flag 402 of the block not in use is “0” as shown in the row 413 in which the block address is p−1.

Similarly, FIG. 5 shows an example in which the snapshot saving volume has q blocks from 0 to q−1. A status flag 502 is recorded for each of saving volume block addresses 501. In the row 511 having the block address of 0, the status flag 502 is “1” so as to represent that the block 0 is in use, and the status flag 502 is “0” since the blocks of the block addresses s and q−1 are not in use. These status flags 402 and 502 are updated when each subprogram of the snapshot management program 104 is operated.

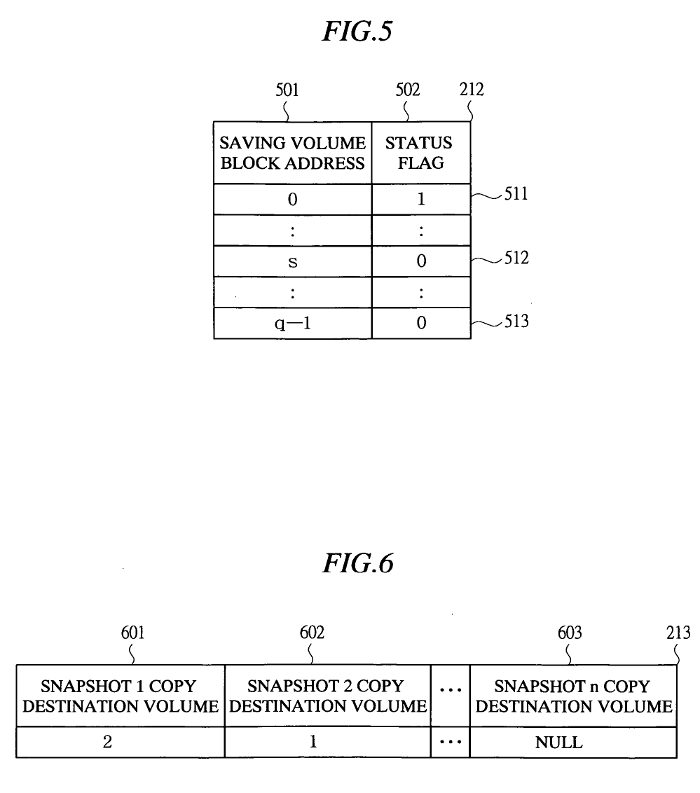

The copy destination management table 213 retains the copy destination volume of the difference data generated when keeping the snapshot. When the snapshot is created, the difference data is copied to the difference storing volume. However, when the difference data is generated after moving the snapshot to the snapshot saving volume, the copy destination needs to be changed to the snapshot saving volume. The table is necessary for this process. FIG. 6 shows an example thereof. Similar to the example of the block copy management table 211, each of the volumes is denoted by a number.

For example, the copy destination of the snapshot 1 can be known by referencing the column 601. Then, since the volume is “2”, the difference is copied to the snapshot saving volume. Similarly, since the copy destination volume of the snapshot 2 is “1” as shown in the column 602, it is copied to the difference storing volume. Also, since the copy destination volume of the snapshot n is “null” as shown in the column 603, it can be understood that the snapshot is not created.

Hereinafter, the process flow of the subprogram group which constitutes the snapshot management program 104 will be described with reference to FIGS. 7 to 15.

FIG. 7 shows an example of the process flow of the operation of the initialization subprogram 201. When executing the initialization subprogram 201, the operation volume and the difference storing volume, and the snapshot saving volume are specified. Then, the management table group corresponding to the configuration of the volumes is initialized.

First, the block copy management table is initialized in accordance with the size of the operation volume (S701). At this time, all of the entries of the column corresponding to each snapshot are set to “null”. Next, the used block management table is initialized (S702). At this time, both the used block management tables for the difference storing volume and the snapshot saving volume are initialized. Then, the copy destination management table is initialized (S703). All contents of the copy destination management table corresponding to each snapshot are set to “null”. This program is ended when the initialization of these tables is executed.

FIG. 8 shows an example of the process flow of the operation of the snapshot creation subprogram 204. When executing the snapshot creation subprogram 204, the number of snapshot to be created is specified. This number is used to determine the column of the table to be operated.

First, the initial value is set for the block copy management table (S801). More specifically, in the columns corresponding to the number of the snapshots specified when executing the program, the volumes and blocks of all block addresses are set to “0”. Then, the difference storing volume is set in the copy destination management table (S802). That is, “1” which represents the difference storing volume is set to the column corresponding to the number of the snapshot specified when executing the snapshot creation subprogram 204. However, since the difference data is always copied to the difference storing volume when creating the snapshot in this case, the process as described above is performed. It is also possible to specify that the difference data is copied to the snapshot saving volume at the time when creating the snapshot. In this case, it is necessary to specify the copy destination volume of the difference data when executing the snapshot creation subprogram 204.

FIG. 9 shows an example of the process flow of the operation of the snapshot deletion subprogram 205. When executing the snapshot deletion subprogram 205, the number of snapshot to be deleted is specified.

First, the value at the time of initialization is set in the block copy management table (S901). That is, in the columns corresponding to the number of the snapshot to be deleted, all of the volumes and blocks are set to “null”. At this time, since the block used for the snapshot is released, the status flag of the used block management table is updated (S902). More specifically, the block to which the difference data which becomes unnecessary due to the deletion of the snapshot is copied is made reusable. Next, the value at the time of initialization is set in the copy destination management table (S903). That is, “null” is set to the column corresponding to the number of the snapshot to be deleted. This program is ended when the management table group is returned to the state before creating the snapshot by the processes described above.

FIG. 10 shows an example of the process flow of the operation of the read operation subprogram 202. The read operation can be executed for the operation volume and the snapshot created by the snapshot creation subprogram 204.

First, the read request is received and it is determined whether or not the read from the snapshot is requested (S1001). If the read from the snapshot is not requested (NO), the data is read from the specified block of the operation volume (S1003) and the program is ended. If the read from the snapshot is requested (YES), the block copy management table corresponding to the block of the requested snapshot is referenced to determine whether or not the value of the copy destination address is “0” (S1002). If it is “0” (YES), since the difference data is not copied, the data is read from the specified block of the operation volume (S1003) and the program is ended. If it is not “0” (NO), since the difference data has been copied, the data is read from the volume/block specified by the copy destination in the block copy management table (S1004), and the program is ended.

FIG. 11 shows an example of the process flow of the operation of the write operation subprogram 203. When the data write process to the operation volume is performed, the difference data of the snapshot is copied to the difference storing volume and the snapshot saving volume at the same time, thereby keeping the snapshot. The write operation is performed in response to the request which specifies the data to be written, the volume, and the block address.

First, when the write request is received, one snapshot is selected from the block copy management table 211 (S1101). Then, it is determined whether or not the copy destination address of the block to be written specified by the write request is “0” with reference to the block copy management table 211 (S1102). If the copy destination address is “0” (YES), since the copy of the difference data is necessary, the process is performed subsequently. The volume of the copy destination is recognized from the copy destination management table, and then, the block with the status flag “0” in the copy destination volume is selected from the used block management table (S1103). Thereafter, since the block is used as the copy destination of the difference data, the status flag in the used block management table is changed to “1” (S1104).

Thereafter, the data of the operation volume in the block to which the data is written is copied to the selected volume (S1105). The numbers of the volume and the block in the block copy management table are changed to those of the selected volume and block (S1106). Then, it is determined whether or not the process is finished for all snapshots (S1107). If the process is not finished yet (NO), the process of selecting the snapshot (S1101) is performed again. If the process is finished for all snapshots (YES), the data write to the operation volume is performed (S1108), and the program is ended. Also, if the copy destination address is not “0” in S1102 (NO), the process of S1107 is performed because the difference data has been already copied or the snapshot is not created.

Although the copy is performed for all of the snapshots which require the copy of the difference data in this embodiment, the number of copies can be reduced. For its achievement, the blocks of the snapshots having the same volume specified in the copy destination management table are saved in the block copy management table 211 by one copy operation. By performing this in each copy destination volume, the snapshot can be kept. In this case, however, it is necessary to change the snapshot deletion subprogram. That is, when deleting the snapshot, it is determined whether or not each of the blocks is not saved in the block copy management table by the other created snapshot, and if it has been saved, the used block management table is not changed.

FIG. 12 shows an example of the process flow of the operation of the snapshot moving subprogram 206. In this process, the snapshot in the difference storing volume is moved and saved in the snapshot saving volume. When executing the program, the number of the snapshot stored in the difference storing volume is specified.

First, the copy destination volume of the snapshot to be moved in the copy destination management table is changed (S1201). If the copy of the difference data of the snapshot to be moved is performed thereafter, the difference data is copied not to the difference storing volume but to the snapshot saving volume. Then, the block for the snapshot to be moved is selected from the block copy management table (S1202). More specifically, the process as follows is performed to all blocks of the snapshot. It is determined whether or not the copy destination block of the selected block in the block copy management table is “0” (S1203). If it is “0” (YES), the process is directed to S1209 because the difference data of this block is not copied. On the other hand, if it is not “0” (NO), the process from S1204 to S1208 is performed.

First, the block with the status flag “0” is selected from the used block management table of the snapshot saving volume (S1204), and the status flag of the selected block in the used block management table is updated (S1205). That is, the status flag is changed to “1” representing that the block is in use. Next, in order to move the difference data in the difference storing volume to the snapshot saving volume, the data is copied to the block selected from the blocks in the block copy management table (S1206). Then, the volume and the block of the block copy management table are updated (S1207) so as to reference the data in the snapshot saving volume.

Since the data of the difference storing volume is not referenced thereafter, in order to release the block of the difference storing volume, the status flag of the copy source block in the used block management table is updated (S1208). More specifically, the status flag is changed to “0”. It is determined whether or not the process is finished for all blocks because the process is performed to blocks equivalent to the size of the snapshot (S1209). If finished (YES), the program is ended, and if not finished (NO), the process from S1202 is repeated as many times as the number of blocks.

FIGS. 13 and 14 show an example of the process flow of the operation of the saving volume separation subprogram 207. This program is executed for temporarily separating the snapshot saving volume from the operation.

First, a region for storing the block copy management table is created in the saving volume (S1301). For example, the storing region is preferably saved in the initial block of the volume in advance, and the table is read therefrom in the read operation. Next, the snapshot whose copy destination is the snapshot saving volume is selected (S1302). Thereafter, the process for all blocks of the selected snapshot is repeatedly performed. Therefore, the block is first selected from the block copy management table (S1303). Then, it is determined whether or not the copy destination block thereof is “0” (S1304). At this time, if it is not “0” (NO), the process of S1309 for the next block is performed. If it is “0” (YES), the process of copying the data not copied to the snapshot saving volume is performed.

First, in order to acquire the block to which the data is copied, the block with the status flag “0” is selected from the used block management table (S1305). Then, the status flag of the selected block in the used block management table is changed to “1” (S1306) so as to prevent other data from being copied. The data of the corresponding block of the operation volume is copied to the selected block (S1307) and saved. Furthermore, the device and the block of the block copy management table are updated by using the information of the copy destination block (S1308). By doing so, it is possible to access the data even after separating the snapshot saving volume. Then, it is determined whether or not the process is finished for all blocks (S1309), and if not finished (NO), the process for each block is repeated in S1303. If finished (YES), the process of S1401 is performed.

In order to separate the snapshot saving volume, the process of copying the data of all snapshots whose difference data is retained in the snapshot saving volume is required. Therefore, it is determined whether or not process is finished for all of the snapshots in the block copy management table (S1401), and if not finished (NO), the process of the S1302 is repeated until the process is finished for all of the snapshots. If finished (YES), the block copy management table is written to the snapshot saving volume (S1402). At this time, the values of copy destination volumes and blocks of the snapshots whose difference data is stored in the difference storing volume are set to “null” in each block of the table.

Then, since the access to the snapshot in the snapshot saving volume is stopped, the block copy management table and the copy destination management table are changed (S1403). In this change, similar to the case of the snapshot deletion, the volumes and blocks and the copy destinations of the corresponding snapshots are set to “null”. Then, since the saving volume becomes unused, the used block management table of the saving volume is changed (S1404), and the program is ended. In this change, the used block management table is deleted from the memory.

FIG. 15 shows an example of the process flow of the operation of the saving volume reconnection subprogram 208. By the execution of this program, the snapshot in the snapshot saving volume separated by the saving volume separation subprogram 207 becomes accessible.

First, the block copy management table is read from the saving volume (S1501). It is preferable that the table is read from the location decided in advance when saving it by the saving volume separation subprogram 207. After reading the table, the block copy management table for the reconnected saving volume is created (S1502). More specifically, the block copy management table for the reconnected snapshot saving volume is created independently from other operation volume, difference storing volume, and the snapshot saving volume. By doing so, the access independent from other snapshots is enabled.

As described above, by the reconnection of the snapshot saving volume and making the snapshot accessible, the data can be recovered to the operation volume from the snapshot. For example, by reading all blocks of the snapshot and writing them to the operation volume, the data can be recovered in the operation volume. Alternatively, in the case where the file system is created and used in the operation volume, since the snapshot can be recognized as the file system, the data can be recovered in the file system in the operation volume in units of file.

In this embodiment, one snapshot saving volume is used. However, a plurality of snapshot saving volumes can be used by applying a simple modification. For example, the used block management table is created for each of the snapshot saving volumes and the volume to which the snapshot is moved is specified by the snapshot moving subprogram. Also, a number is allocated to each snapshot saving volume and written to the block copy management table. By doing so, a plurality of snapshot saving volumes can be used while utilizing the process described in this embodiment.

Further, it is also possible to add a new volume for the snapshot saving volume. For example, in the case where the block copy management table cannot be read by the snapshot reconnection subprogram, by recognizing the volume as the new snapshot saving volume and creating a new used block management table for the volume, the new snapshot saving volume can be changed so as to be used by the snapshot moving subprogram.

As described above, it is possible to copy the data of the snapshot among a plurality of volumes.

### Second Embodiment

In this embodiment, the method of saving the snapshot in which the data copy from the operation volume other than the copy of difference data is reduced will be described.

The configuration of the system is identical to that of the first embodiment. However, the snapshot saving volume is changed so that a reference destination snapshot is saved therein. In addition, the saving volume separation subprogram and the saving volume reconnection subprogram are changed in the following manner.

In the separation of the volume, the saving volume separation subprogram copies the block not copied as the difference data from the operation volume. Instead, the number of the latest snapshot in the snapshot saving volume is saved together with the block copy management table. Then, in the block copy management table in the memory, the snapshot corresponding to the saved number is made undeletable and the copy of the difference data is continued.

The process of reading the saved number of the snapshot from the reconnected snapshot saving volume is added to the saving volume reconnection subprogram. Then, the number is associated with the snapshot saving volume and retained in the memory. Also, the value showing that the reference destination snapshot of the snapshot saving volume which is not reconnected and is connected from the start of the operation is the operation volume is retained in the memory.

A process is added to the read operation subprogram when the data is read from the snapshot and the block of the block copy management table is “0”. In the first embodiment, when the block is “0”, the data is read from the operation volume unconditionally. In this embodiment, however, the number of reference destination snapshot is first read from the memory, and then, the data is read from the block of the snapshot corresponding to the number. In this manner, when referencing the snapshot in the reconnected snapshot saving volume, since the data of the snapshot which continues to copy the difference data is combined, it is possible to maintain the consistency of the snapshot.

As described above, it is possible to reduce the data copy generated at the time of separation of the snapshot saving volume.

By using the transmission of the snapshot data according to the present invention, the protection of various data stored in the storage system can be enabled. Particularly, in the case where the snapshot is retained over a prolonged period, a large number of snapshots can be saved in a plurality of volumes.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to a technique for realizing a snapshot function in a storage system. Particularly, it is effectively applied to the method of creating and keeping a snapshot by using a logical volume manager.

What is claimed is:

1. A method of keeping a snapshot, which is executed in a storage system comprising a server system and a storage subsystem having a plurality of storage medium,
wherein the server system uses a first storage media of the storage subsystem as an operation volume,
the server system uses a second storage media different from said first storage media as a difference volume,
the server system uses a third storage media different from said first storage media as a saving volume,
a difference at data update of the operation volume is saved in the difference volume and the saving volume by the server system, and a snapshot of the operation volume is created and kept by managing data location, and
data of the difference volume is moved to the saving volume based on information of a table which manages the data location, thereby copying the snapshot to the saving volume.

2. The method of keeping a snapshot according to claim 1,
wherein data of the operation volume not stored in the saving volume is copied to the saving volume,
the table which manages the data location is changed so as to maintain the consistency of the snapshot, and the table is stored in the saving volume, and
the saving volume to which the snapshot is copied can be separated from the storage system.

3. The method of keeping a snapshot according to claim 2,
wherein the separated saving volume to which the snapshot is copied can be reconnected, and the snapshot thereof can be referenced.

4. The method of keeping a snapshot according to claim 3,
wherein data of the snapshot can be recovered to the operation volume from the reconnected saving volume.

5. The method of keeping a snapshot according to claim 1,
wherein the table which manages the data location is changed so as to maintain the consistency of the snapshot, and the table is stored in the saving volume,
the consistency of the snapshot copied to the saving volume is maintained by referencing a snapshot constituted by the operation volume and the difference volume, and
the saving volume to which the snapshot is copied can be separated from the storage system.

6. The method of keeping a snapshot according to claim 5,
wherein the separated saving volume to which the snapshot is copied can be reconnected, and the snapshot thereof can be referenced.

7. The method of keeping a snapshot according to claim 6,
wherein data of the snapshot can be recovered to the operation volume from the reconnected saving volume.
